(19) United States
(12) Patent Application Publication
(10) Pub. No.: US 2011/0147263 A1
(43) Pub. Date: Jun. 23, 2011

(54) PROCESS AND SYSTEM TO CONVERT OLEFINS TO DIESEL AND OTHER DISTILLATES

(75) Inventors: Benjamin S. UMANSKY, Fairfax, VA (US); Michael C. CLARK, Glenmills, PA (US); Carlos N. LOPEZ, Amissville, VA (US); Katherine L. WEIGER, Falls Church, VA (US)

(73) Assignee: EXXONMOBIL RESEARCH AND ENGINEERING COMPANY, Annandale, NJ (US)

(21) Appl. No.: 12/905,369

(22) Filed: Oct. 15, 2010

Related U.S. Application Data
(60) Provisional application No. 61/287,854, filed on Dec. 18, 2009.

(51) Int. Cl. C10L 1/16; B01J 8/04

(52) U.S. Cl. 208/15; 585/14; 422/618; 422/187

(57) ABSTRACT

The present invention provides a process for producing a hydrocarbon fuel composition that includes introducing an olefin feed composition including light olefins to an oligomerization catalyst to yield an intermediate composition including olefins having at least four carbon atoms, introducing the intermediate composition and a second feed of aromatic compounds (e.g., a feed including from 2 to 99.9% benzene or other alkylatable aromatics) to an aromatic alkylation catalyst to yield a fractionation feed to provide a composition which can be further refined to provide one or more hydrocarbon fuel compositions.

### CROSS REFERENCE TO RELATED APPLICATION

This application relates and claims priority to U.S. Provisional Patent Application No. 61/287,854 filed on Dec. 18, 2009.

### FIELD OF THE INVENTION

The present invention relates to processes and systems that provide for the conversion of olefins to diesel and/or other distillate products.

### BACKGROUND OF THE INVENTION

It is believed by some that, in the future, the increase in demand for diesel and other distillate products will outpace the increase in demand for gasoline. Accordingly, there is a need for additional techniques for obtaining diesel and other distillate fuels.

Light olefins are produced in typical hydrocarbon refining operations that also produce mogas and distillate products. There is a desire to obtain higher amounts of mogas and diesel end products per unit volume of crude oil extracted upstream. To supplement obtaining diesel from newly-extracted crude oil, and to meet the rising demand for diesel and other distillates, it is desirable to make use of light olefins to yield additional diesel and other distillate products.

It is also possible to obtain olefins from natural gas and coal sources via conversion of methanol and other oxygenates via the use of zeolite catalysts. While processes exist to convert olefins to gasoline, it would also be advantageous to provide more economically efficient methods of converting olefins to diesel and other distillate products. There is a thus desire to provide an economically feasible process to move conversions based on light olefins out of the mogas pool and into the diesel pool by oligomerization and aromatic alkylation reactions.

### SUMMARY OF THE INVENTION

One aspect of the present invention provides a process for producing a hydrocarbon fuel composition that includes introducing an olefin feed composition including light olefins (e.g., C₂ to C₆ olefins) to an oligomerization catalyst to yield an intermediate composition including olefins having at least four carbon atoms, introducing the intermediate composition and a second feed of aromatic compounds (e.g., a feed containing from 2 to 99.9% alkylatable aromatics) to an aromatic alkylation catalyst to yield a hydrocarbon fuel composition.

Another aspect of the present invention provides a system for producing a hydrocarbon fuel composition that includes an olefin feed including light olefins (e.g., C₂ to C₆ olefins), a first reaction vessel containing an oligomerization catalyst in fluid communication with the first feed to yield an intermediate composition including olefins having at least four carbon atoms, a second reaction vessel containing an aromatic alkylation catalyst in fluid communication with a second feed of aromatic compounds and the intermediate composition to yield a hydrocarbon fuel composition, and a collection assembly in fluid communication with the second reaction vessel to recover the hydrocarbon fuel composition from the stream exiting the reaction vessel containing the aromatic alkylation catalyst.

### BRIEF DESCRIPTION OF THE DRAWINGS

The invention will now be described in conjunction with the accompanying drawings in which:

FIG. 1 is a conceptual process flow diagram demonstrating conversion of a C₂-C₆ olefin feed to a diesel and gasoline fuel composition, and a C₂-C₆ paraffinic composition.

FIG. 2 is a conceptual process flow diagram depicting reformate alkylation within a diesel reactor system.

FIG. 3 is a conceptual process flow diagram for a FCC naptha and scanfinate alkylation process in accordance with a single feed embodiment of the present invention.

FIG. 4 is a plot demonstrating the conversion of benzene, 1-hexene and toluene as described in Example 1.

FIG. 5 is a plot based on the GC analysis of the feed and product, as described in Example 1.

FIG. 6 depicts an ASTM D86 test method analysis of the aromatic feed and alkylated product after reaction with hexene, as described in Example 1.

FIG. 7 depicts an ASTM D86 test method analysis of an alkylated product after reaction with propylene and an alkylated aromatic product after reaction with hexane.

FIG. 8 is a second GC analysis of the feed and product of Example 1.

### DETAILED DESCRIPTION OF THE INVENTION

### Definitions

As used herein, the term “produced in an industrial scale” refers to a production scheme in which gasoline and/or distillate end products are produced on a continuous basis (with the exception of necessary outages for plant maintenance) over an extended period of time (e.g., over at least a week, or a month, or a year) with the expectation of generating revenues from the sale or distribution of the gas and/or distillate. Production at an industrial scale is distinguished from laboratory or pilot plant settings which are typically maintained only for the limited period of the experiment or investigation, and are conducted for research purposes and not with the expectation of generating revenue from the sale or distribution of the gasoline or distillate produced thereby.

As used herein, and unless specified otherwise, “gasoline” or “gasoline boiling range components” refers to a composition containing at least predominantly C₅-C₁₂ hydrocarbons. In one embodiment, gasoline or gasoline boiling range components is further defined to refer to a composition containing at least predominantly C₅-C₁₂ hydrocarbons and further having a boiling range of from about 100° F. to about 360° F. In an alternative embodiment, gasoline or gasoline boiling range components is defined to refer to a composition containing at least predominantly C₅-C₁₂ hydrocarbons, having a boiling range of from about 100° F. to about 360° F., and further defined to meet ASTM standard D439.

As used herein, and unless specified otherwise, the term “distillate” or “distillate boiling range components” refers to a composition containing predominately C₁₀-C₄₀ hydrocarbons. In one embodiment, distillate or distillate boiling range components is further defined to refer to a composition containing at least predominately C₁₀-C₄₀ hydrocarbons and further having a boiling range of from about 300° F. to about 1100° F. Examples of distillates or distillate boiling range components include, but are not limited to, naphtha, jet fuel, diesel, kerosene, aviation gas, fuel oil, and blends thereof.

As used herein, and unless specified otherwise, the term “diesel” refers to middle distillate fuels containing at least predominantly C₁₂-C₂₅ hydrocarbons. In one embodiment, diesel is further defined to refer to a composition containing at least predominantly C₁₂-C₂₅ hydrocarbons, and further having a boiling range of from about 330° F. to about 700° F. In an alternative embodiment, diesel is as defined above to refer to a composition containing at least predominantly C₁₂-C₂₅ hydrocarbons, having a boiling range of from about 330° F. to about 700° F., and further defined to meet ASTM standard D975.

For those embodiments of the presently disclosed subject matter in which the hydrocarbon fuel composition includes diesel, the cetane value for the recovered diesel can vary. In one embodiment the recovered diesel has a cetane number of at least 35, or alternatively has a cetane value of at least 40, or still alternatively has a cetane value of at least 45.

As used herein, a feed is rich in a certain component if it contains at least 50 wt % of that component. In certain embodiments, a feed is rich in a certain component contains at least 75 wt %, or at least 90 wt %, at least 95 wt % or at least 99 wt % of that component.

As used herein, a SPA-type catalyst refers to a catalyst which contains as one of its principal raw ingredients an acid of phosphorus such as ortho-, pyro- or tetraphosphoric acid.

As used herein, a MWW-type catalyst is a catalyst having the MWW framework topology, as classified by the Structure Commission of the International Zeolite Association according to the rules of the IUPAC Commission on Zeolite Nomenclature, and includes, for example, zeolites PSH-3, MCM-22, MCM-49, MCM-56, SSZ 25, ERB-1 and ITQ-1 catalysts.

As used herein, the term “alkylatable aromatics” refers to aromatic compounds that can be alkylated under suitable alkylation conditions. While benzene is the prototypical alkylatable aromatic, it is understood that alkylatable aromatics can also include—in addition to benzene—toluene, xylenes and lower alkyl benzenes (e.g., ethylbenzene). It should also be understood that reference to benzene in this application in the context of alkylation reactions also encompasses other alkylatable aromatics in addition to benzene, such as those compounds described above.

Reference will now be made to various aspects and embodiments of the presently disclosed subject matter in view of the definitions above.

One aspect of the present invention provides a process for producing a hydrocarbon fuel composition (e.g., diesel or other distillate) that includes introducing an olefin feed composition including light olefins (e.g., a composition containing C₂ to C₆ olefins) to an oligomerization catalyst (e.g., a MCM-22, ZSM-22 or ZSM-57 catalyst) to yield an intermediate composition including olefins having at least four carbon atoms (e.g., a composition that includes at least 1 wt %, or at least 5 wt %, or at least 10 wt %, or at least 25 wt %, or at least 50 wt % C₅-C₁₆ olefin oligomers), introducing the intermediate composition and a second feed of aromatic compounds (e.g., a feed including from 2 to 99.9% of alkylatable aromatics) to an aromatic alkylation catalyst (e.g., a MCM-22 type catalyst) to yield a fractionation feed to provide a composition which can be further refined to provide one or more hydrocarbon fuel compositions (e.g., C₂-C₆ paraffins, gasoline and a distillate (e.g., diesel)). In one embodiment the hydrocarbon fuel composition is produced in an industrial scale.

The olefin feed composition can be obtained utilizing existing process streams within a hydrocarbon refining plant, from chemical grade olefin sources, or a mixture thereof. In one embodiment, the olefin feed composition is obtained from fuel gas, chemical grade propylene, refinery grade propylene, polymer grade propylene, liquefied petroleum gas (LPG), light cracked naptha (LCN) process streams, scafinate (hydroprocessed LCN) process streams, de-hydrogenated INN process streams (light virgin naptha), and butylene or butylene-containing process streams (e.g., an alkylation feed). In another embodiment, the olefin feed composition is obtained from a FCC coking operation, such as a FCC off-gas or coker off-gas stream, or from a steam cracking operation.

The olefin oligomer content in the intermediate stream can vary depending on the olefin content in the olefin feed stream, which in turn may vary depending on the source of the olefin feed stream. While the intermediate stream in some embodiments of the presently disclosed subject matter contains at least 50 wt % olefins oligomers (e.g., at least 50 wt % C₅-C₁₆ olefin oligomers), other embodiments that employ a more dilute olefin feed stream will provide an intermediate with a lower concentration of olefins oligomers (e.g., at least 5 wt %, or at least 10 wt %, or at least 25 wt % C₅-C₁₆ olefin oligomers).

Similarly, the feed of aromatic compounds can be obtained from existing process streams within a hydrocarbon refining plant. In one embodiment, the aromatic compounds are obtained from light reformate, a benzene heart-cut reformate, heavy reformate, full reformate or catalytic cracked naptha (cat naphtha), virgin naptha, or hydrocracked naptha process streams.

The oligomerization catalyst can be a solid phosphoric acid (SPA) catalyst, a MWW type catalysts or a ZSM-type catalyst. The oligomerization catalyst can be selected from, for example, a MCM-22 catalyst, a ZSM-22 catalyst or a ZSM-57 catalyst, or a combination thereof. In one embodiment the aromatic catalyst is a MCM-22 catalyst. Other solid acid catalysts can be employed and optimized to provide desired product properties.

The oligomerization catalyst can be contained in a reaction vessel. In one embodiment, the reaction vessel containing the oligomerization catalyst is a fixed bed reaction vessel. The fixed bed reaction vessel can be of a chamber design or a tubular design. In one embodiment, the reaction vessel containing the oligomerization catalyst is maintained at a pressure of from about 200 psig to about 1500 psig and/or at a temperature of from about 100° F. to about 600° F.

The aromatic alkylation catalyst can also be contained in a reaction vessel. In one embodiment, the vessel containing the aromatic alkylation catalyst is a fixed bed reaction vessel. The fixed bed reaction vessel can be of a chamber design or a tubular design. In one embodiment, the vessel containing the aromatic alkylation catalyst is maintained at a pressure from about 50 or 100 psig to about 1000 or 1500 psig and at a temperature of from about 80 or 100° F. to about 600° F.

Another aspect of the present invention provides a system for producing a hydrocarbon fuel composition that includes an olefin feed including C₂ to C₆ olefins, a first reaction vessel containing an oligomerization catalyst in fluid communication with the olefin feed to yield an intermediate composition including olefins having at least four carbon atoms, a second reaction vessel containing an aromatic alkylation catalyst in fluid communication with a second feed of aromatic compounds and the intermediate composition to yield a hydrocarbon fuel composition, and a collection assembly in fluid communication with the second reaction vessel to recover the hydrocarbon fuel composition from the stream exiting the reaction vessel containing the aromatic alkylation catalyst.

Exemplary further embodiments of the present invention are provided below for illustrative purposes, and not for purposes of limitation. Reference to the system will be made in conjunction with and understood from the method disclosed herein.

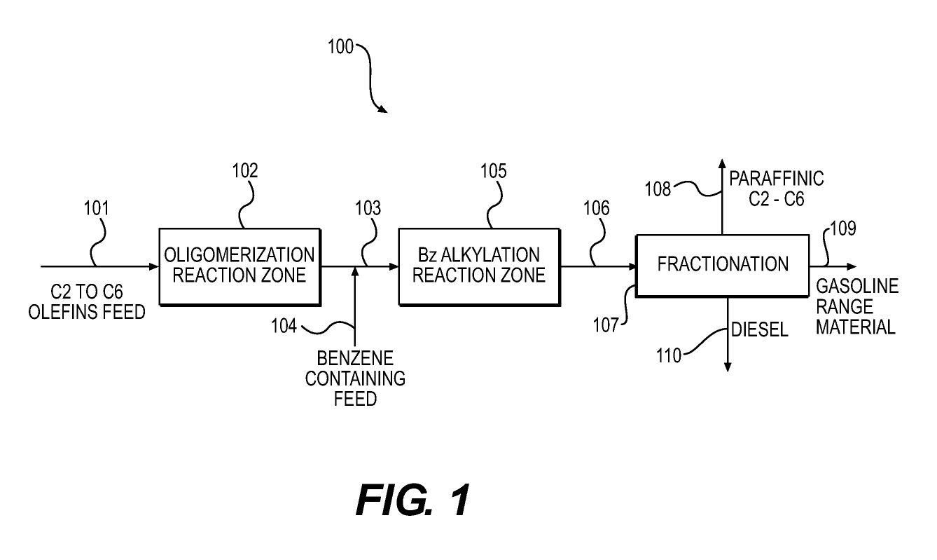

An exemplary process flow diagram (100) is shown in FIG. 1. An olefin feed composition (101) containing C₂ to C₆ olefins is introduced to an oligomerization reaction zone (102), which can include an oligomerization catalyst housed in a reaction vessel (e.g., a fixed bed reactor containing an oligomerization catalyst). Besides olefins, the olefin feed composition can also contain paraffins, hydrogen, and/or other inert compounds.

Referring still to FIG. 1, an intermediate composition (103), containing C₉-C₁₆ olefins is combined with a benzene containing feed (104), and the combined stream is introduced to an benzyl (or aromatic) reaction zone (105), which can include an aromatic alkylation catalyst housed in a reaction vessel (e.g., a fixed bed reaction vessel). The product (106) of the benzyl (or aromatic) reaction zone is then introduced to a fractionation operation (107), in which a C₂-C₆ paraffinic composition (108), a gasoline boiling range material (109) and a diesel boiling range material (110) is provided as end products. The fractionation operation can include fractionation columns or stills, which can be operated under reaction conditions known to those of ordinary skill in the art.

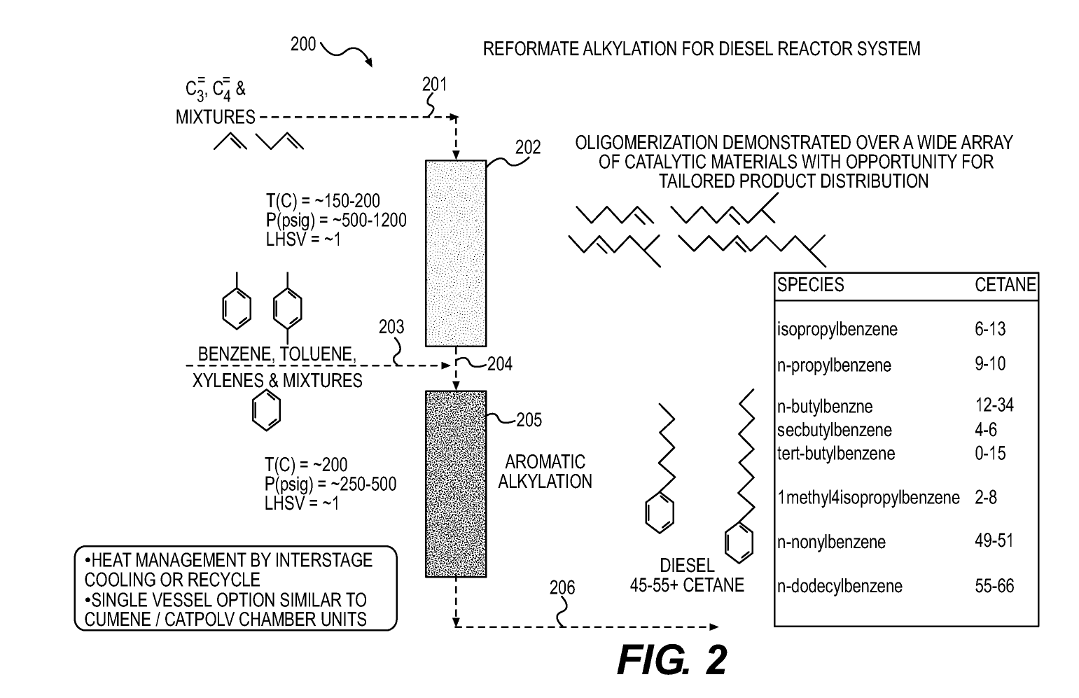

FIG. 2 provides another exemplary embodiment of the present invention, in which a conceptual process configuration (200) is shown which produces diesel end-product with a cetane rating of 45-55+. A feed (201) is provided which can be rich in C₃ olefins, or rich in C₄ olefins, or alternatively can contain a mixture of C₃ and C₄ olefins. The feed is introduced to a fixed bed reaction vessel (202) containing an oligomerization catalyst. In this embodiment, the vessel (202) is maintained a temperature of about 150-200° C. and a pressure of about 500 to about 1200 psig. The LHSV is from about 0.1 to 10 hr⁻¹, preferably about 1 hr⁻¹, based on the total amount of olefin feed.

Referring still to FIG. 2, the oligomerized olefin stream exiting the reaction vessel (202) is combined with a reformate stream or feed (203) of benzene, toluene, and xylenes, and the combined stream (204) is introduced to fixed bed reaction vessel (205) containing a aromatic alkylation catalyst. In this embodiment, the vessel (205) is maintained at a temperature of about 200° C. and a pressure of from about 250 psig to about 500 psig. The LHSV is about 1 hr⁻¹, based on the amount of olefin feed. The product (206) leaving the reaction vessel will contain alkylated aromatic compounds that can be recovered to obtain a diesel fuel composition with a cetane rating of 45-55+. For example, the end product can contain n-nonylbenzene and/or n-dodecylbenzene, which have cetane ratings of 49-51 and 55-68 respectively. It is expected that different product isomers will be formed having a range of cetane numbers.

The heat generated by reaction vessels (202) and (205) can be managed by interstage cooling or by recycle streams. Reaction vessels 202 and 205 can exist as two physical reactors, or alternatively they can be combined into a single vessel.

Olefin feeds containing rich in near linear olefins with a minimum of five carbon atoms are, in certain embodiments, preferred in order to provide a diesel fuel composition with higher cetane ratings. Benzene rings with an n-alkyl substituent from 6 to 9 carbon atoms have a cetane rating between about 40 and 50.

### Oligomerization Reaction Zone

As noted above, an olefin feed composition is introduced to an oligomerization catalyst to provide an intermediate composition that includes oligomerized olefins. In certain embodiments of the present invention, the oligomerization catalyst will be contained within a vessel (e.g., a reactor), which is referred to herein as the first reaction vessel. A person of ordinary skill in the art can determine the proper reaction conditions, and thus the proper conditions for the first reaction vessel, in order to convert a feed containing, for example, C₂-C₆ olefins to yield an intermediate composition containing at least four carbon atoms (e.g., a composition containing C₄-C₁₆ olefins).

In certain embodiments the vessel containing the oligomerization catalyst (i.e. the first reaction vessel) is maintained at a temperature ranging from about 100° F. to about 600° F. more preferably from about 200 to 400° F. In certain embodiments, the vessel containing the oligomerization catalyst is maintained at a pressure ranging from about 200 psig to about 1500 psig, more preferably from about 400 to about 1100 psig.

In certain embodiments, the conversion of the olefin feed composition after being contacted with the oligomerization catalyst ranges from about 50 to 100%, or from about 70 to 99%, or from about 80 to 95%. The process can be operated at a lower conversion if necessary, for example if the refinery were economically balancing the production of LPG. A person of ordinary skill in the art can adjust the flow rate and operating temperature of the olefin feed composition in order to operate at the desired oligomerization conversion. In one embodiment, the olefin feed can be operated over a range of 0.1 to 10 LHSV and over a temperature range of 200-400° F.

Suitable oligomerization reaction conditions are also disclosed in U.S. Published Patent Application No. 2007/0173676, which is hereby incorporated by reference in its entirety.

### Olefin Feed Composition

The ultimate product distribution can change based on the olefin feed composition entering the oligomerization reaction zone. If the olefin feed composition is rich in C₃ olefins, the first reactor will yield an intermediate composition rich in C₆-C₁₂+ olefins. Alternatively, if the olefin feed composition is rich in C₄, olefins, the product produced in the largest quantity will be C₈-C₁₆+ olefins. If the feed contains a mixture of C₃ and C₄ olefins, the product produced in the largest quantity will be C₆-C₁₆ olefins. Generally higher oligomers are preferred such that they produce molecules within the distillate boiling range as these higher oligomers tend to produce alkylaromatics with higher cetane values. It is preferred to select an oligomerization catalyst that provided near linear oligomers as increasing linearity of the oligomer corresponds to increasing cetane of the resulting alkylaromatic.

Accordingly, one embodiment includes selecting a feed rich in C₃ olefins for use in the process of the present invention, as described anywhere in this application, in order to obtain a hydrocarbon fuel composition rich in C₆-C₁₂+ olefins. An alternative embodiment includes selecting a feed rich in C₄ olefins for use in the process of the present invention, as described anywhere in this application, in order to obtain a hydrocarbon fuel composition rich in C₈-C₁₆+ olefins.

### Aromatic Alkylation Reaction Zone

The intermediate composition obtained from the oligomerization reaction zone, and a second feed of aromatic compounds is introduced to an aromatic alkylation catalyst to provide a hydrocarbon fuel composition. The intermediate composition can be combined with the second feed of aromatic compounds upstream from the aromatic alkylation catalyst such that one feed containing both the intermediate composition and aromatic compounds is introduced to the aromatic alkylation catalyst. Alternatively, the intermediate composition and the second feed of aromatic compounds can be introduced separately to the aromatic alkylation catalyst. In certain embodiments of the present invention, the aromatic alkylation catalyst will be contained within a vessel (e.g., a reactor), which is referred to herein as the second reaction vessel.

A person of ordinary skill in the art can determine the proper reaction conditions, and thus the proper conditions for the second reaction vessel, in order to convert a feed that includes, for example, an intermediate composition (e.g., a feed containing C₉-C₁₆ olefins) and a second feed of aromatic compounds (e.g., a feed containing 2-99.9% benzene and other alkylatable aromatics) to yield a composition which includes a hydrocarbon fuel composition. The hydrocarbon fuel composition can be recovered (i.e., further isolated) using refining and separation techniques known to those of ordinary skill in the art.

The amount of alkylatable aromatics in the second feed of aromatic compounds can vary. For example, the second feed of aromatic compounds can include at least 1 wt %, or at least 5 wt %, or at least 10 wt % of alkylatable aromatics, based on the total weight of the second feed of aromatic compounds.

In certain embodiments the vessel containing the aromatic alkylation catalyst (i.e., the second reaction vessel) is maintained at a temperature ranging from about 80° F. to about 600° F., or from about 100° F. to about 400° F. In certain embodiments, the vessel containing the aromatic alkylation catalyst is maintained at a pressure ranging from about 50 psig to about 1500 psig, or from about 100 psig to about 1000 psig.

The conversion of aromatic compounds can vary. In one embodiment, the conversion of aromatic compounds ranges from about 50% to about 100%. Higher aromatic conversions are preferred to maximize the amount of distillate produced

The feed amount of aromatic compounds and intermediate composition to the aromatic alkylation reaction zone can also vary. It is desirable to operate with a molar ratio of Olefin:Aromatic of 0.5 to 3, more preferably about 1.

In certain embodiments, the oligomerization catalyst and aromatic alkylation catalyst are housed in separate vessels. Alternatively, the oligomerization catalyst and aromatic alkylation catalyst can be housed in the same vessel. In embodiments in which the oligomerization catalyst and aromatic alkylation catalyst are housed in the same vessel, it is understood that reaction conditions for the respective vessels refer to reaction conditions for that portion of the vessel that contains the oligomerization catalyst, or aromatic alkylation catalyst, as appropriate.

### Single Feed Option

In certain embodiments of the present invention, the pre-oligomerization step is eliminated and a composition containing olefins having at least three carbon atoms is combined with an aromatic feed, and the combined stream is introduced to an aromatic alkylation catalyst (e.g., a MCM-22 type catalyst) to yield a hydrocarbon fuel composition. For example, existing streams within a hydrocarbon refinery that contain both olefins and aromatics (an FCC Naptha stream and/or a scanfinate stream) can be introduced to an aromatic alkylation catalyst to yield diesel fuel.

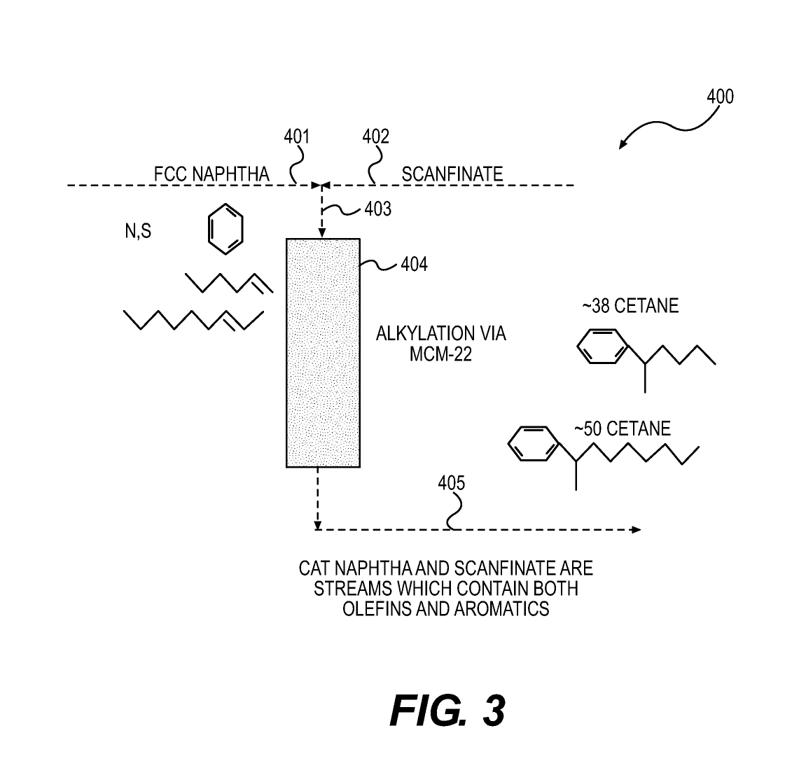

An exemplary single feed embodiment is shown in FIG. 3. A FCC Naptha stream (401) is combined with a scanfinate stream (402), and the combined stream (403) is introduced to a fixed bed reactor (404) containing MCM-22 catalyst. Prior to being introduced to the catalyst, nitrogen and sulphur containing compounds are removed from the FCC Naptha stream, since these components cause detrimental effects on the catalyst. In this example, the FCC Naphtha stream (401) contains about 20-30% linear olefins (as a percentage of total olefin content), with the balance being primarily mono-branched olefins. The resulting product stream (405) contains a diesel fuel composition.

### Oligomerization Catalysts

As disclosed in U.S. Pat. No. 7,361,798, which is hereby incorporated by reference, zeolites are classified by the Structure Commission of the International Zeolite Association according to the rules of the IUPAC Commission on Zeolite Nomenclature. A framework-type describes the topology and connectivity of the tetrahedrally coordinated atoms constituting the framework and makes an abstraction of the specific properties for those materials. Molecular sieves for which a structure has been established are assigned a three letter code and are described in the Atlas of Zeolite Framework Types, 5^{th} edition, Elsevier, London, England (2001), which is hereby incorporated by reference in its entirety.

Unless specified otherwise, the oligomerization catalysts of the present invention is without limitation so long as it facilitates the oligomerization of an olefin feed composition. In one embodiment, the oligomerization catalyst is selected from a solid phosphoric acid catalyst (SPA), a MWW type catalyst and a ZSM-type catalyst.

Solid phosphoric acid (SPA) catalysts are known in the art and are commercially available, for example, from UOP LLC (Des Plaines, Ill.). Further details regarding the composition and production of SPA catalysts can be obtained from U.S. Pat. Nos. 3,050,472; 3,050,473; and 3,132,109, which are each hereby incorporated by reference in their entirety.

As disclosed in U.S. Published Application No. 2007/0173676, which is hereby incorporated by reference in its entirety, the SPA catalyst can be provided with a carrier, such as a naturally occurring porous silica-containing materials (e.g., kieselguhr, kaolin, infusorial earth and diatomaceous earth). As disclosed therein, the SPA catalyst can also be employed in conjunction with crystalline molecular sieve catalysts, such as, for example, ZSM-22, ZSM-23, SAPO-11, ZSM-48 or other molecular sieve catalysts described herein or otherwise known in the art.

MWW type catalysts are also known in the art and can be commercially obtained from, for example, ExxonMobil Catalyst Technologies LLC (Baytown, Tex.). As disclosed in U.S. Published Application No. 2006/0194999, which is hereby incorporated by reference, the MWW family of zeolite materials has achieved recognition as having a characteristic framework structure which presents unique and interesting catalytic properties. The MWW topology consists of two independent pore systems: a sinusoidal ten-member ring [10 MR] two dimensional channel separated from each other by a second, two dimensional pore system comprised of 12 MR super cages connected to each other through 10 MR windows. The crystal system of the MWW framework is hexagonal and the molecules diffuse along the directions in the zeolite, i.e., there is no communication along the c direction between the pores. In the hexagonal plate-like crystals of the MWW type zeolites, the crystals are formed of relatively small number of units along the c direction as a result of which, much of the catalytic activity is due to active sites located on the external surface of the crystals in the form of the cup-shaped cavities. MWW-type catalysts that can be used in connection with the presently disclosed subject matter include, but are not limited to, PSH-3, MCM-22, MCM-36, MCM-49, MCM-56, SSZ-25, ERB-1, EMM-1, EMM-2, and ITQ-1 catalysts.

In one embodiment, the MWW type catalyst is selected from a MCM catalyst (e.g., MCM-22, MCM-36, MCM-49, and MCM-56 catalyst). MCM catalysts are known in the art, and can be obtained from, for example from ExxonMobil Catalyst Technologies LLC (Baytown, Tex.). MCM type catalysts, including synthesis details, are described in, for example, U.S. Pat. Nos. 7,198,711; 5,639,931; 5,296,428; 5,1460,29; and U.S. Published Application No. 2006/0194998. Each of these references are hereby incorporated by reference in their entirety.

In one embodiment, the MWW type catalyst is a MCM-22 catalyst. MCM-22 is described in U.S. Pat. No. 4,954,325 as well as in U.S. Pat. Nos. 5,250,777; 5,284,643 and 5,382,742. MCM-49 is described in U.S. Pat. No. 5,236,575; MCM-36 in U.S. Pat. No. 5,229,341 and MCM-56 in U.S. Pat. No. 5,362,697. Each of these patents are hereby incorporated by reference in their entirety.

In another embodiment, the oligomerization catalyst is a EMM catalyst (e.g., EMM-1 or EMM-2 catalyst). EMM catalysts are known in the art and are preferably obtained from ExxonMobil Catalyst Technologies LLC (Baytown, Tex.). Synthesis details regarding EMM catalysts can be found, for example, in U.S. Pat. Nos. 7,255,849 and 6,787,124 and U.S. Published Application Nos. 2006/0079723, 2009/0163753, each of which are hereby incorporated by reference in its entirety.

In one embodiment, the oligomerization catalyst is a ZSM-type catalyst. ZSM (Zeolite Socony Mobil) catalysts are known in the art and can be commercially obtained or synthesized. Commercially available ZSM-type catalysts can be obtained from, for example, Zeolyst International Corporation (Valley Forge, Pa.), BASF Catalysts LLC (Iselin, N.J.), Sud-Chemie Incorporated (Louisville, Ky.), and, preferably, from ExxonMobil Catalyst Technologies LLC (Baytown, Tex.). ZSM catalysts, including synthesis details, are generally described, for example, in U.S. Pat. Nos. 5,367,100; 4,845,063; 4,872,968; 4,076,842; 4,046,859; 4,035,430; 4,021,331; 4,016,245; 3,972,983; 3,965,205; 3,832,449; 3,709,979; 3,702,886; 3,303,069; and Re. 28,341. The contents of each of these patents is hereby incorporated by reference in their entirety.

In one embodiment, the oligomerization catalyst is a ZSM-type catalyst selected from ZSM-5, ZSM-11, ZSM-12, ZSM-22, ZSM-23, ZSM-35, ZSM-48, ZSM-50, ZSM-57 catalysts. In one embodiment, the ZSM-type catalyst is selected from ZSM-23 and ZSM-57, or a combination thereof. In one embodiment the oligomerization catalyst is a combination of a ZSM-23 and ZSM-57 catalyst, since this combination yields a high amount of linear olefins.

In one embodiment, the oligomerization catalyst is an ITQ type catalysts. ITQ type catalysts, including synthesis details, are described in, for example, U.S. Pat. Nos. 7,449,169; 7,081,556; 6,709,572; and 6,469,226, as well as published U.S. Application No. 2008/0021253. Each of these references are hereby incorporated by reference in their entirety.

In one embodiment, the ITQ type catalyst is ITQ-13. ITQ-13 structure is 10×10×9-member rings. Pore sizes of the ITQ-13 are 4.8×5.3 A; 4.8×5.1 A; 4.0×4.8 A (9-member ring).

Other molecular sieves catalysts can be used as the oligomerization catalyst. These catalysts include those described in R. Szostak, Handbook of Molecular Sieves, Van Nostrand Reinhold, New York, N.Y. (1992), which is hereby incorporated by reference in its entirety.

### Aromatic Alkylation Catalysts

Unless specified otherwise, the aromatic alkylation catalysts of the present invention is without limitation so long as it facilitates the aromatic alkylation of an intermediate olefin composition. In one embodiment, the aromatic alkylation catalyst is a MWW framework type catalyst, including the MWW type catalyst described above. In one embodiment, the MWW type catalyst is a MCM-22 catalyst. It is also contemplated that zeolites beta catalyst and USY catalysts may be used.

### EXAMPLES

The present application is further described by means of the examples, presented below. The use of such examples is illustrative only and in no way limits the scope and meaning of the invention or of any exemplified term. Likewise, the invention is not limited to any particular preferred embodiments described herein. Indeed, many modifications and variations of the invention will be apparent to those skilled in the art upon reading this specification. The invention is therefore to be limited only by the terms of the appended claims along with the full scope of equivalents to which the claims are entitled.

### Example 1

A feed including 30.8 wt % 1-hexene, 17.0 wt % benzene, 3.4 wt % toluene and the additional components identified below in Table 1 was prepared.

TABLE 1
Composition of Feed composition

| | |
|---|---|
| 4000 n-Butane | 0.0728 |
| 4001 Iso-Butane | 0.0101 |
| 4098 Other C4 Paraffins | 0.0008 |
| 4101 C-2-Butene | 0.0000 |
| 4102 T-2-Butene | 0.0000 |
| 4104 1-Butene + Iso-Butene | 0.0000 |
| 5000 n-Pentane | 1.0945 |
| 5001 Iso-Pentane | 1.0712 |
| 5098 Other C5 Paraffins | 0.0088 |
| 5100 1-pentene | 0.0000 |
| 5101 cis-2-pentene | 0.0046 |
| 5102 T-2-Pentene | 0.0075 |
| 5103 2M Butene-1 | 0.0000 |
| 5104 3-methyl-1-butene | 0.0024 |
| 5105 2M-Butene-2 | 0.0282 |
| 5200 Cyclopentane | 0.3506 |
| 6000 n-Hexane | 8.2458 |
| 6001 2M Pentane | 7.5930 |
| 6002 3M Pentane | 6.2668 |
| 6003 2,2 DM Butane | 1.2242 |
| 6004 2,3 DM Butane | 1.4955 |
| 6098 Other C6 Paraffins | 0.5906 |
| 6100 1-hexene | 30.8069 |
| 6101 cis-2-hexene | 0.0447 |
| 6102 trans-2-hexene | 0.0873 |
| 6107 4-methylpentene-1 | 0.0093 |
| 6108 2-methyl-pentene-2 | 0.1220 |
| 6181 1M Cyclopentene | 0.0126 |
| 6200 Methylcyclopentane | 1.9176 |
| 6201 Cyclohexane | 0.3778 |
| 6300 Benzene | 16.9667 |
| 7000 n-Heptane | 2.8404 |
| 7001 2M Hexane | 3.9279 |
| 7002 3M Hexane | 4.6536 |
| 7004 2,2 DM Pentane | 0.6836 |
| 7005 2,3 DM Pentane | 1.4432 |
| 7006 2,4 DM Pentane | 0.5797 |
| 7008 2,2,3 TM Butane | 0.0998 |
| 7098 Other C7 Paraffins | 0.7355 |
| 7100 1-heptene | 0.0000 |
| 7101 cis-2-heptene | 0.0240 |
| 7102 trans-2-heptene | 0.0154 |
| 7103 cis-3-heptene | 0.0612 |
| 7104 trans-3-heptene | 0.0000 |
| 7200 Ethylcylopentane | 0.1381 |
| 7203 1-T-2 DM Cyclopentane | 0.0193 |
| 7204 1-C3 DM Cyclopentane | 0.1804 |
| 7205 1-T3 DM Cyclopentane | 0.1682 |
| 7206 Methylcyclohexane | 0.1428 |
| 7300 Toluene | 3.3618 |
| 7300 Toluene | 3.3618 |
| 8000 n-Octane | 0.1878 |
| 8002 3M-Heptane | 0.2465 |
| 8005 2,4 DM Hexane | 0.0062 |
| 8016 2,3,4 TM Pentane | 0.0072 |
| 8098 Other C8 Paraffins | 1.4233 |
| 8100 1-octene | 0.0034 |
| 8101 cis-2-octene | 0.0112 |
| 8102 trans-2-octene | 0.0107 |
| 8300 EthylBenzene | 0.1003 |
| 8301 O-Xylene | 0.0347 |
| 8302 M-Xylene | 0.1485 |
| 8303 P-Xylene | 0.0820 |
| 8320 Styrene | 0.0000 |
| 9000 n-Nonane | 0.0000 |
| 9098 Other C9 Paraffins | 0.0513 |
| 9100 1-nonene | 0.0000 |
| 9300 NC3 Benzene | 0.0056 |
| 9301 IC3Benzene | 0.0016 |
| 9302 1M2ET Benzene | 0.0000 |
| 9303 1M3ET Benzene | 0.0000 |
| 9304 1M4ET Benzene | 0.0094 |
| 9305 123TM Benzene | 0.0000 |
| 9306 124TM Benzene | 0.0140 |
| 9307 135TM Benzene | 0.0045 |
| 9370 Indane | 0.0000 |
| 9398 Other C9 Aromatics | 0.0318 |
| 10000 n-Decane | 0.0000 |
| 10098 Other C10+ Paraffins | 0.0070 |
| 10100 1-decene | 0.0000 |
| 10300 N-butyl Benzene | 0.0000 |
| 10301 Iso-butyl Benzene | 0.0049 |
| 10302 Sec-butyl Benzene | 0.0862 |
| 10304 1M2NP Benzene | 0.0026 |
| 10305 1M3NP Benzene | 0.0000 |
| 10306 1M4NP Benzene | 0.0000 |
| 10307 1M2IP Benzene | 0.0017 |
| 10308 1M3IP Benzene | 0.0037 |
| 10309 1M4IP Benzene | 0.0000 |
| 10310 12DET Benzene | 0.0036 |
| 10311 13DET Benzene | 0.0000 |
| 10312 14DET Benzene | 0.0000 |
| 10313 12DM3ET Benzene | 0.0000 |
| 10314 12DM4ET Benzene | 0.0033 |
| 10315 13DM2ET Benzene | 0.0000 |
| 10316 13DM4ET Benzene | 0.0023 |
| 10317 13DM5ET Benzene | 0.0000 |
| 10318 14DM2ET Benzene | 0.0000 |
| 10319 1234TM Benzene | 0.0000 |
| 10320 1235TM Benzene | 0.0014 |
| 10321 1245TM Bz | 0.0000 |
| 10360 Naphthalene | 0.0000 |
| 10370 M-Indane | 0.0000 |
| 10398 Other C10 Aromatics | 0.0163 |

The feed was passed over a MCM-49 catalyst containing a 80/20 zeolite:binder ratio and 1/20″ quadrulube in a fixed bed reactor about 1″ in diameter. 177 g/hr of feed was passed over 63 g of the catalyst at around 400° F. and 600 psig.

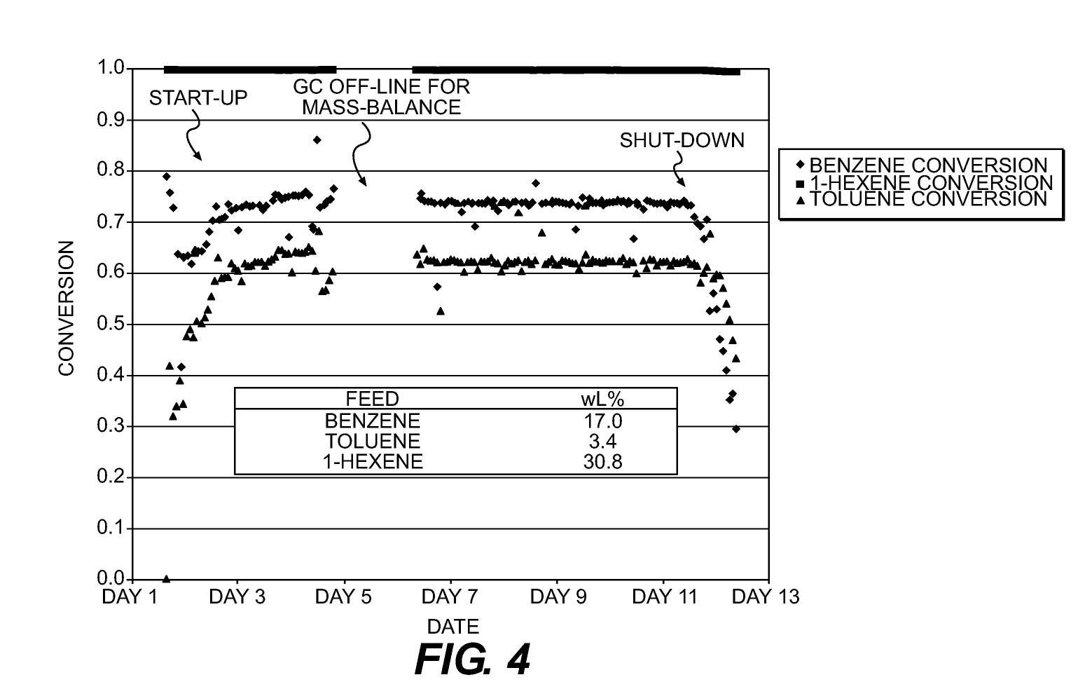

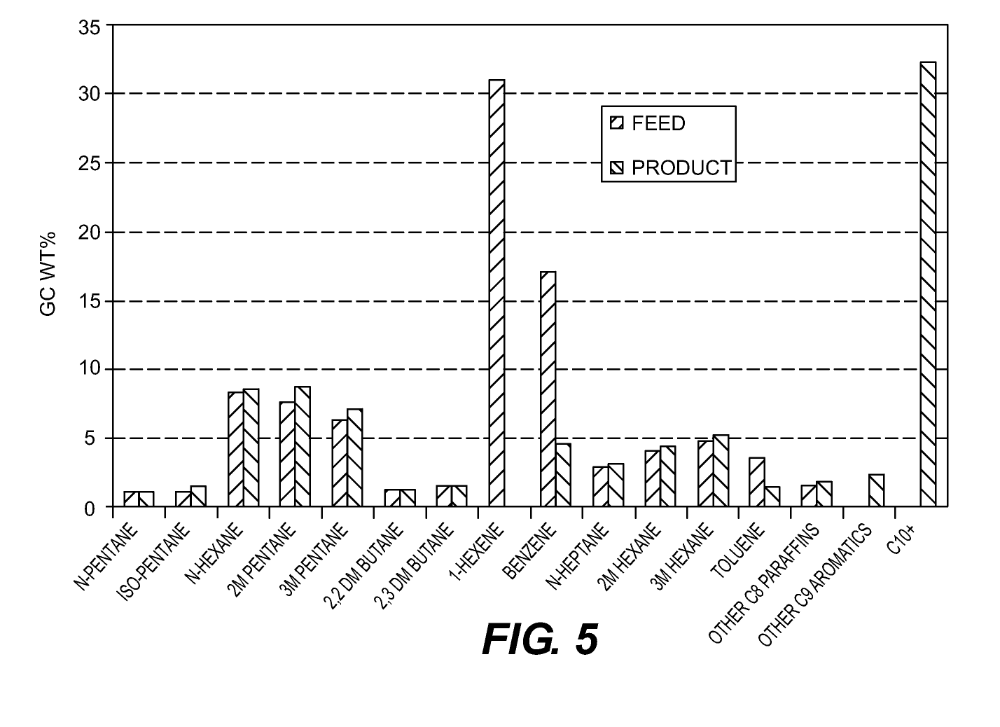

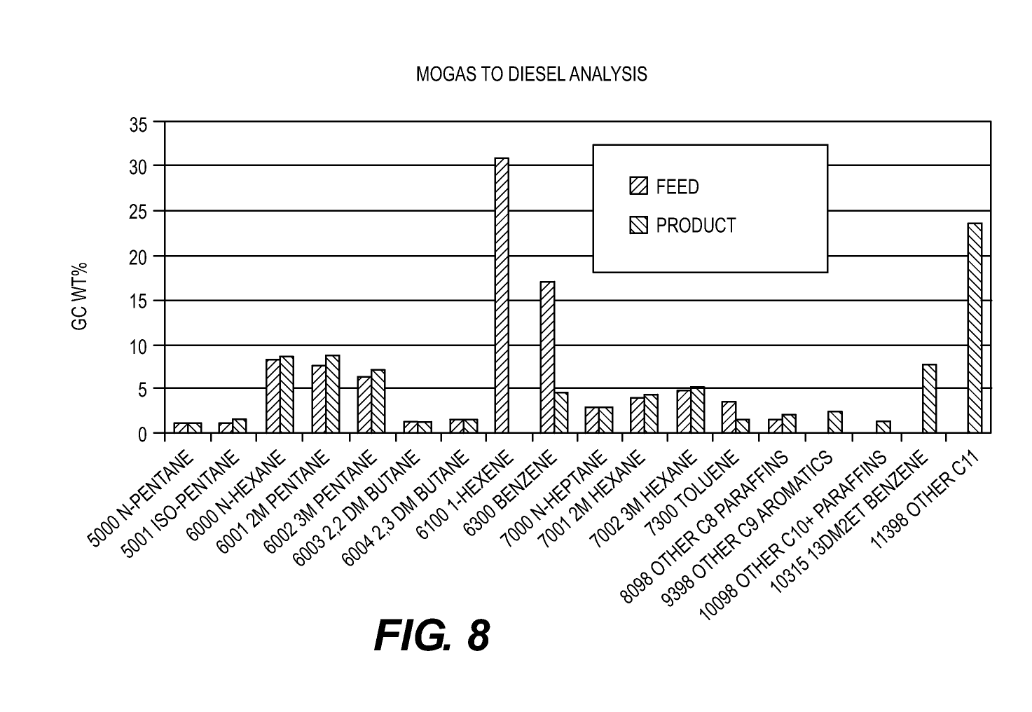

The resulting product was analyzed by gas chromatography (“GC”). The conversion of the feed is shown in FIG. 4 and FIG. 8. The weight percentage of the feed and product, as analyzed by GC is shown in FIG. 2. The majority of the product was C₁₀+, shown in FIG. 5.

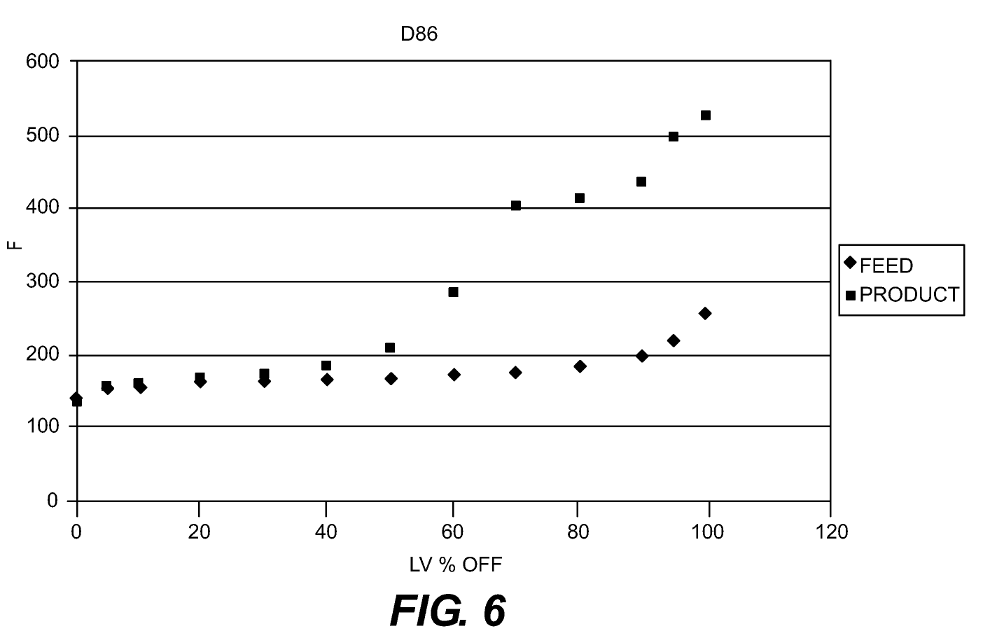

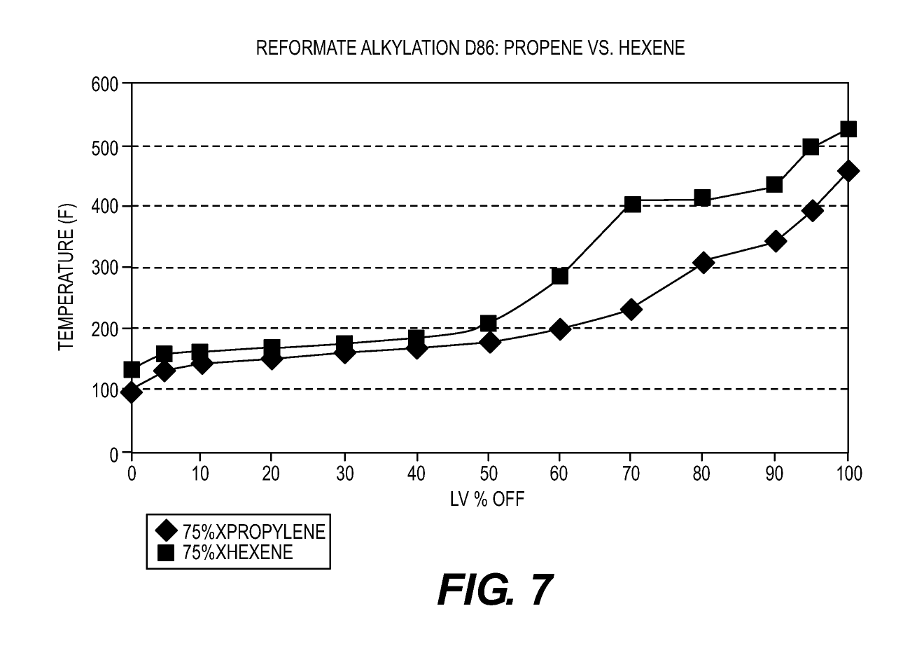

An ASTM D86 analysis of feed and typical product is shown in FIGS. 6 and 7. ASTM D86 is a standard test method known to those skilled in the art. There, the movement in MW of the feed from the mogas boiling range to the distillate boiling range can be seen. The y-axis represents the boiling point in degrees F. and the x-axis represents the liquid volume % off the sample at each corresponding boiling point temperature.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

It is further to be understood that all values are approximate, and are provided for description.

Patents, patent applications, publications, product descriptions, and protocols are cited throughout this application, the disclosures of each of which is incorporated herein by reference in its entirety for all purposes.

1. A process for producing a hydrocarbon fuel composition comprising:
(a) introducing an olefin feed composition including C₂ to C₆ olefins to an oligomerization catalyst to yield an intermediate composition including olefins having at least four carbon atoms;
(b) introducing the intermediate composition and a second feed of aromatic compounds to an aromatic alkylation catalyst to yield a fractionation feed containing a hydrocarbon fuel composition;
(c) recovering the hydrocarbon fuel composition from the fractionation feed.

2. The process of claim 1, wherein the an olefin feed composition is obtained from fuel gas, chemical grade propylene, refinery grade propylene, polymer grade propylene, liquefied petroleum gas (LPG), light cracked naptha (LCN), scanfinate, de-hydrogenated light virgin naptha (LVN), a butylene containing stream, an alkylation feed, FCC off-gas, or coker off-gas.

3. The process of claim 1, wherein the oligomerization catalyst is selected from a solid phosphoric acid (sPa) type catalyst, a MWW framework type catalyst and a ZSM framework type catalyst.

4. The process of claim 3, wherein the catalyst is selected from MCM-22, MCM-36, MCM-49, MCM-56, EMM-1, EMM-2 or a combination thereof.

5. The process of claim 3, wherein the catalyst is selected from ZSM-22, ZSM-23, ZSM-57 or a combination thereof.

6. The process of claim 1, wherein the olefin feed composition is introduced to the oligomerization catalyst in a first reaction vessel maintained at from about 200 psig to about 1500 psig at a temperature of from about 100° F. to about 600° F.

7. The process of claim 1, wherein the intermediate composition includes at least 10 wt % C₄-C₁₆ olefins.

8. The process of claim 1, wherein the second feed of aromatic compounds is obtained from light reformate, benzene heart-cut reformate, heavy reformate, full reformate, catalytic cracked naptha (cat naphtha), coker naptha, virgin naptha or hydrocracked naptha.

9. The process of claim 1, wherein the second feed of aromatic compounds contains at least 10% alkylatable aromatics.

10. The process of claim 1, wherein the aromatic alkylation catalyst is a MWW type catalyst.

11. The process of claim 10, wherein the MWW type catalyst is a MCM-22 or MCM-49 catalyst.

12. The process of claim 1, wherein the intermediate composition and the second feed of aromatic compounds is introduced to the aromatic alkylation catalyst in a second reaction vessel maintained at from about 50 psig to about 1500 psig at a temperature of from about 80° F. to about 600° F.

13. The process of claim 12, wherein the second reaction vessel is a fixed bed reactor of chamber or tubular design.

14. The process of claim 13, wherein the aromatic alkylation catalyst is a MWW framework type catalyst.

15. The process of claim 1, wherein the hydrocarbon fuel composition is diesel.

16. The process of claim 15, wherein recovering the diesel includes separating by fractionation material having a boiling point of from about 350° F. to about 700° F.

17. The process of claim 16, wherein the diesel has a cetane number of at least 35.

18. The process of claim 1, wherein the hydrocarbon fuel composition is selected from, naphtha, jet fuel, diesel, kerosene, aviation gas, fuel oil, and blends thereof.

19. A process for forming a hydrocarbon fuel composition comprising:
(a) introducing a first feed including olefins having at least three carbon atoms and a second feed of aromatic compounds to an aromatic alkylation catalyst to yield a fractionation feed containing a hydrocarbon fuel composition; and
(b) recovering the hydrocarbon fuel composition from the fractionation feed.

20. The process of claim 19, wherein the second feed of aromatic compounds is obtained from light reformate, heavy reformate, full reformate and catalytic cracked naptha (cat naphtha).

21. The process of claim 19, wherein the aromatic alkylation catalyst is a MWW type catalyst.

22. The process of claim 21, wherein the MWW type catalyst is a MCM-22 or MCM-49 catalyst.

23. The process of claim 19, wherein the hydrocarbon fuel composition is diesel.

24. The process of claim 19, further including introducing a pre-feed feed including C₂ to C₆ olefins to an oligomerization catalyst to yield the first feed including olefins having at least four carbon atoms.

25. A system for producing a hydrocarbon fuel composition comprising:
(a) an olefin feed composition including C₂ to C₆ olefins;
(b) a first reaction vessel containing an oligomerization catalyst in fluid communication with the first feed to yield an intermediate composition including olefins having at least four carbon atoms;
(d) a second reaction vessel containing an aromatic alkylation catalyst in fluid communication with a second feed of aromatic compounds and the intermediate composition to yield a hydrocarbon fuel composition;
(e) a collection assembly in fluid communication with the second reaction vessel to recover the hydrocarbon fuel composition from the stream exiting the reaction vessel containing the aromatic alkylation catalyst.

26. The system of claim 25, wherein the an olefin feed composition is obtained from fuel gas, chemical grade propylene, liquefied petroleum gas (LPG) or light cracked naptha (LCN).

27. The system of claim 25, wherein the oligomerization catalyst is selected from solid phosphoric acid (sPa), a MWW type catalyst and a ZSM type catalysts.

28. The system of claim 25, wherein the intermediate composition is at least 10 wt % C₅-C₁₆ olefins.

29. The system of claim 25 wherein the second feed of aromatic compounds is obtained from light reformate, heavy reformate, full reformate and catalytic cracked naptha (cat naphtha).

30. The system of claim 25, wherein the aromatic alkylation catalyst is a MWW type catalyst.

31. The system of claim 25, wherein the second reaction vessel is a fixed bed reactor of chamber or tubular design.

32. The system of claim 25, wherein the hydrocarbon fuel composition is diesel.

33. The system of claim 25, wherein the collection assembly includes a fractionating column.

34. A system for forming a hydrocarbon fuel composition comprising:
(a) a first feed including olefins having at least four carbon atoms;
(c) a first reaction vessel containing an aromatic alkylation catalyst in fluid communication with the first feed and a second feed of aromatic compounds to yield a hydrocarbon fuel composition;
(d) a collection assembly in fluid communication with the first reaction vessel to recover the hydrocarbon fuel composition.

35. The system of claim 34 wherein the second feed of aromatic compounds is obtained from light reformate, heavy reformate, full reformate and catalytic cracked naptha (cat naphtha).

36. The system of claim 34, wherein the aromatic alkylation catalyst is of MWW type or MCM-22 or MCM-49 catalyst.

37. The system of claim 34, wherein the hydrocarbon fuel composition is diesel.
